(19) United States
(12) Patent Application Publication
(10) Pub. No.: US 2023/0146247 A1
(43) Pub. Date: May 11, 2023

(54) SYSTEMS AND METHODS FOR GRAPHICAL RUNTIME VALIDATED REPORT GENERATION

(71) Applicant: Fortinet, Inc., Sunnyvale, CA (US)

(72) Inventor: Kurt William Goldstein, Concord, NH (US)

(73) Assignee: Fortinet, Inc., Sunnyvale, CA (US)

(21) Appl. No.: 17/522,596

(22) Filed: Nov. 9, 2021

(51) Int. Cl. G06F 11/30; G06F 11/07

(52) U.S. Cl. CPC G06F 11/3086; G06F 11/0709

(57) ABSTRACT

Systems, devices, and methods are discussed that provide for developing custom reports.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2021, Fortinet, Inc.

### FIELD

Embodiments discussed generally relate to report generation, and more particularly to systems, devices, and methods are discussed that provide for graphical report generation.

### BACKGROUND

Various users rely upon reports both to receive and communicate information. Such reports often include a variety of information included in databases, and are often limited use or even one time reports. In many cases because of a lack of database and/or programming skills, or the fact that a report will be of limited use, it is not possible or practical to automatically generate reports. Thus, in many cases a user is left to access a database and manually assemble data into a desired report. Further, to maintain ease-of-use, conventional report generation tool kits are locked to a single view with query filters not extending beyond a single join table and no computation or processing of the data before the report itself is generated.

Thus, there exists a need in the art for more advanced approaches, devices, and systems for generating custom reports.

### SUMMARY

Embodiments discussed generally relate to report generation, and more particularly to systems, devices, and methods are discussed that provide for graphical report generation.

This summary provides only a general outline of some embodiments. Many other objects, features, advantages, and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1B is a block diagram of a report generation system in accordance with various embodiments;

FIGS. 2A-2C is a flow diagram showing a method in accordance with some embodiments for custom report generation; and

FIGS. 3A-3E show an example graphical report generation solution that may be developed using the systems and methods of FIGS. 1-2.

### DETAILED DESCRIPTION

Embodiments discussed generally relate to report generation, and more particularly to systems, devices, and methods are discussed that provide for graphical report generation.

Various embodiments discussed provide one or more advantages in report generation that may include, but are not limited to, ease-of-use, data processing, and portability. Some embodiment use a graphical flow based programming (FBP) model with a visual graph integrated development environment (Graph IDE) of execution flow. In some cases, such an approach allows for generation of custom reports by users without significant technical training. In operation, users drag processing nodes (visually distinct shapes each designed to perform a specific function based upon specific inputs, and provide specific outputs) onto a display or graph and draws connections between the inputs and outputs of respective processing nodes. The connections are used to describe execution flows and data flows. A single processing node may represent a complex series of tasks, reference an additional tool or remote data, or an event within the execution process. Real-time validation of data flows ensure that they user cannot pass invalid or unchecked data into another processing node. Reports generated based upon the graph may be stored in the standardized FBP format for use in associated report engines or submitted directly from the graph IDE to a report engine for real-time feedback during report development.

Functions or tasks performed by processing node allow various data processing functionality. A report may be so complex as to query a set of data, manipulate that data, then request additional data relative to each record, using the newly obtained data to generate a report. Execution flows may be controlled by all of the same flow-control processes available to programming languages, Loops, conditionals, and repeatable sub-Graphs provide all processing capabilities in a visual format.

The graph IDE serves a purpose to generate the FBP file. A report engine executes the FBP file through a compiling and execution process. The report engine includes the capabilities required for the FBP file to interpret the requested flow correctly. Some embodiments discussed herein may allow for an FBP file to be designed by one customer, but shared with several other customers without any changes required for the report engine to generate reports against the new data set.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views of processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

Some embodiments provide methods for graphically generating an output document. The methods include: displaying, by a processing resource, a plurality of graphical process nodes, where each of the plurality of graphical process nodes corresponds to a defined function, and where each of the plurality of process nodes includes at least a defined input and at least a defined output; receiving, by the processing resource, a first selection of a first graphical process node and a second selection of a second graphical process node, where the first graphical process node and the second graphical process nodes are included in the plurality of graphical process nodes; receiving, by the processing resource, a connection selection, where the connection selection commands a connection between the defined output of the first graphical process node and the input of the second graphical process node; checking, by the processing resource, that the defined output of the first graphical process node is compatible with the defined input of the second graphical process node; applying, by the processing resource, the connection selection to yield a process including at least the first graphical process node and the second process node; and running, by the processing resource, the process to generate a user report.

In some instances of the aforementioned embodiments, additional nodes are included that have only one defined input or one defined output. Such nodes may exist at least once each within the root graph, subgraphs, or defined functions.

In some instances of the aforementioned embodiments, receiving the connection selection includes: receiving, by the processing resource, an indication of the second processing node; and receiving, by the processing resource, an indication to move the second processing node near the first processing node. In various instances of the aforementioned embodiments, checking that the defined output of the first graphical process node is compatible with the defined input of the second graphical process node is done upon receiving the connection selection. In some such instances, the first graphical process node includes an internal process to select between a first output type and a second output type, and where checking that the defined output of the first graphical process node is compatible with the defined input of the second graphical process includes selecting one of the first output type or the second output type based at least in part on the defined input of the second graphical process. In other such instances, checking that the defined output of the first graphical process node is compatible with the defined input of the second graphical process includes displaying an error message indicating an incompatibility of the defined output of the first processing node and the defined input of the second processing node.

In some instances of the aforementioned embodiments, the second graphical process node is one of: an event receiver node, a data node, an execution node, or a comment node. In some such instances, the first graphical process node is an event emitter node. In various instances of the aforementioned embodiments, the second graphical process node includes a third graphical process node, a fourth graphical process node, and a fifth graphical process node from the plurality of graphical process nodes. Each of the third graphical process node, the fourth graphical process node, and the fifth graphical process node are interconnected to yield a function of the second graphical process node. In one or more instances of the aforementioned embodiments, running the process to generate a user report includes executing the defined function of the first graphical process node to yield a first output and executing the defined function of the second graphical process node to yield a second output. In some such instances, the defined function of the second graphical process node is generating a report in a defined format, and wherein the second output is the report in the defined output.

Yet other embodiments provide systems for generating reports. The systems include a processing resource; and a non-transitory computer-readable medium coupled to the processing resource. The non-transitory computer-readable medium has stored therein instructions that when executed by the processing resource cause the processing resource to: display a plurality of graphical process nodes, where each of the plurality of graphical process nodes corresponds to a defined function; and where each of the plurality of process nodes includes at least a defined input and at least a defined output; receive a first selection of a first graphical process node and a second selection of a second graphical process node, where the first graphical process node and the second graphical process nodes are included in the plurality of graphical process nodes; receive a connection selection, where the connection selection commands a connection between the defined output of the first graphical process node and the input of the second graphical process node; check that the defined output of the first graphical process node is compatible with the defined input of the second graphical process node; apply the connection selection to yield a process including at least the first graphical process node and the second process node; and run the process to generate a user report.

In some instances of the aforementioned embodiments, the instructions to receive the connection selection include instructions, which when executed by the processing resource cause the processing resource to: receive an indication of the second processing node; and receive an indication to move the second processing node near the first processing node. In one or more instances of the aforementioned embodiments, checking that the defined output of the first graphical process node is compatible with the defined input of the second graphical process node is done upon receiving the connection selection. In some instances of the aforementioned embodiments, the second graphical process node is selected from a group consisting of: an event receiver node, a data node, an execution node, and a comment node. In some cases, the first graphical process node is an event emitter node.

In various instances of the aforementioned embodiments, the second graphical process node includes a third graphical process node, a fourth graphical process node, and a fifth graphical process node from the plurality of graphical process nodes. Each of the third graphical process node, the fourth graphical process node, and the fifth graphical process node are interconnected to yield a function of the second graphical process node. In some instances of the aforementioned embodiments, the instructions to run the process to generate the user report include instructions, which when executed by the processing resource cause the processing resource to execute the defined function of the first graphical process node to yield a first output and executing the defined function of the second graphical process node to yield a second output. In some cases, the defined function of the second graphical process node is generating a report in a defined format, and wherein the second output is the report in the defined output.

Yet other instances of the aforementioned embodiments provide non-transitory computer-readable storage media embodying a set of instructions, which when executed by a processing resource of a computer system, causes the processing resource to: display a plurality of graphical process nodes, where each of the plurality of graphical process nodes corresponds to a defined function; and where each of the plurality of process nodes includes at least a defined input and at least a defined output; receive a first selection of a first graphical process node and a second selection of a second graphical process node, where the first graphical process node and the second graphical process nodes are included in the plurality of graphical process nodes; receive a connection selection, where the connection selection commands a connection between the defined output of the first graphical process node and the input of the second graphical process node; check that the defined output of the first graphical process node is compatible with the defined input of the second graphical process node; apply the connection selection to yield a process including at least the first graphical process node and the second process node; and run the process to generate a user report.

In some instances of the aforementioned embodiments, the instructions to run the process to generate the user report include instructions, which when executed by the processing resource cause the processing resource to execute the defined function of the first graphical process node to yield a first output and executing the defined function of the second graphical process node to yield a second output.

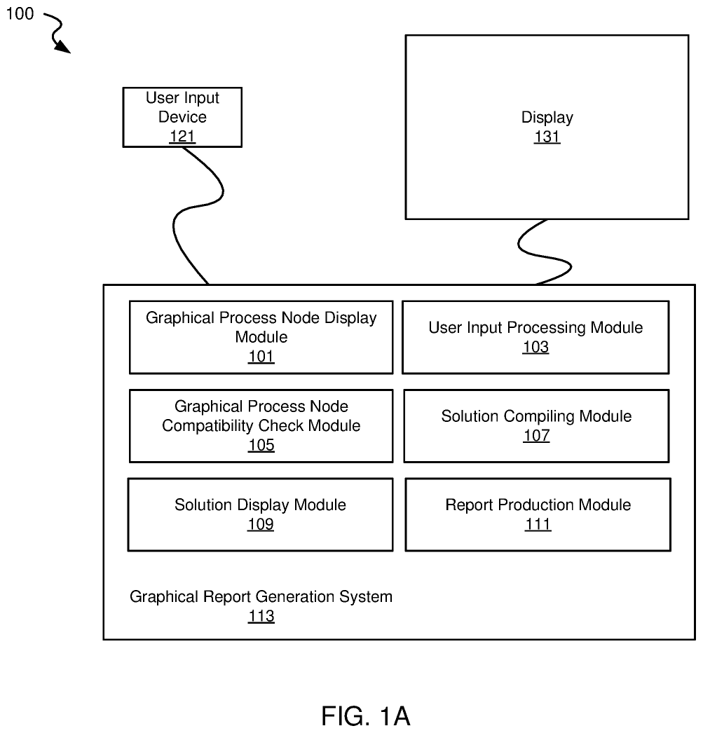

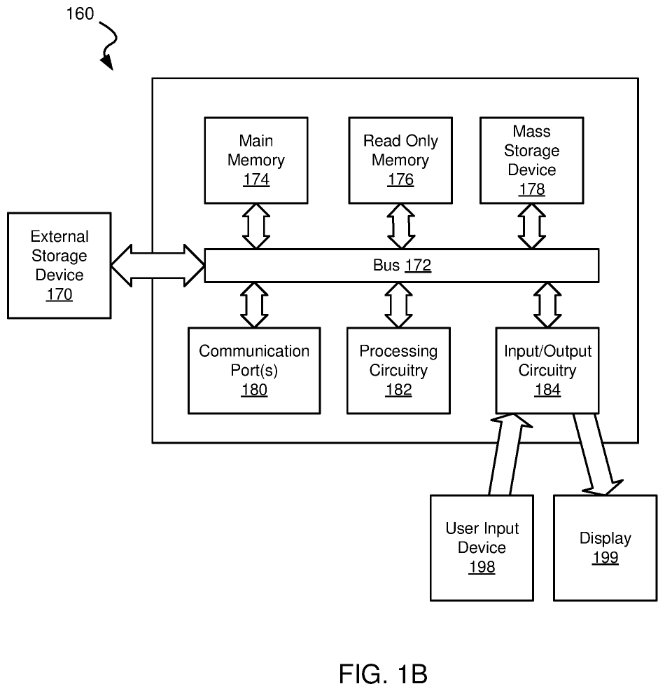

Turning to FIG. 1A, a block diagram of a report generation system 100 is shown in accordance with some embodiments. Report generation system 100 includes a graphical report generation system 113, a display 131, and a user input device 121. User input device 121 may be any user input device known in the art that allows a user to command selection and movement of graphical processing nodes on display 131. Display 131 may be any display known in the art that is capable of showing two or more graphical processing nodes relative to each other.

Graphical report generation system 113 includes a graphical process node display module 101, a user input processing module 103, a graphical processing node compatibility check and connection module 105, a solution compiling module 107, a solution display module 109, and a report production module 111.

Graphical process node display module 101 is configured to access a number of available graphical processing nodes from a storage medium where they are maintained. Such graphical processing nodes are a tool set of graphically represented preprogrammed functions that each perform a defined function and include defined inputs and/or outputs.

User input processing module 103 is configured to receive inputs from user input device 121, and to reflect that received user input on display 131. This may include, selecting a graphical processing node and moving that graphical processing node on display 131 relative to other graphical processing nodes already incorporated into a progressing graphical report generation solution as it is developed.

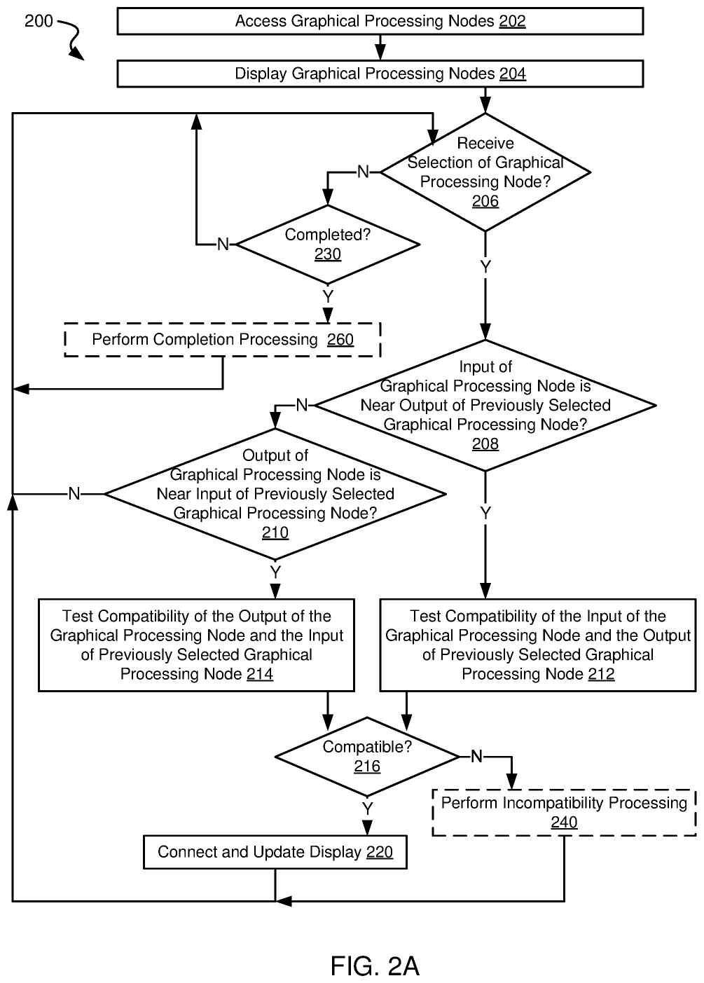

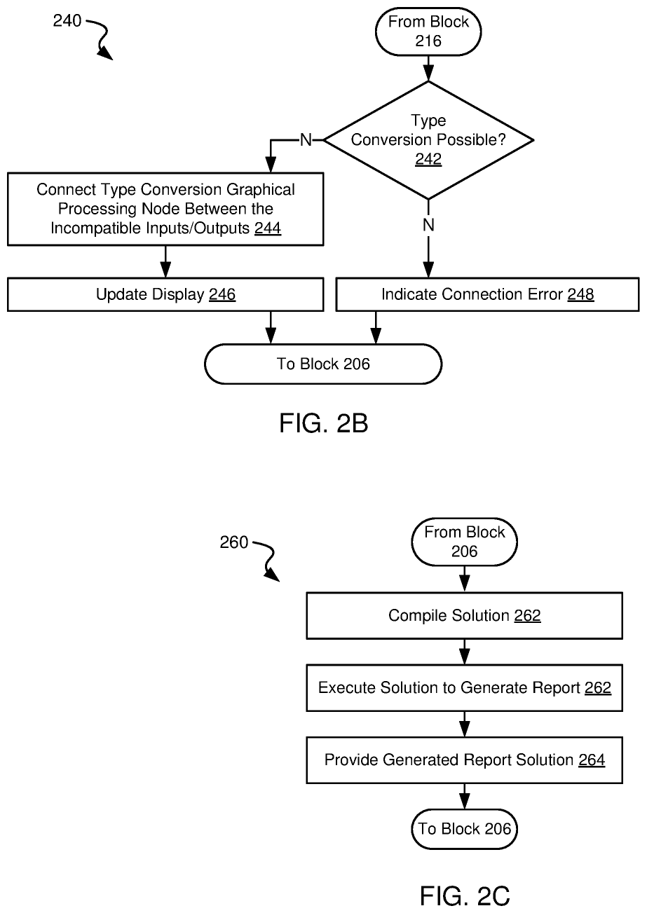

Graphical processing node compatibility check and connection module 105 is configured to check compatibility between inputs and outputs of respective graphical processing nodes that are identified for connection by a user, and for connecting the inputs and outputs where compatibility can be achieved or indicating incompatibility where compatibility cannot be achieved. The function of graphical processing node compatibility check and connection module 105 is more fully described below in relation to FIGS. 2A-2B.

Solution display module 109 is configured to update display 131 to show a progressing graphical report generation solution as it is developed. This includes adding new graphical processing nodes selected by the user and connected to other previously selected graphical processing nodes. In addition, this includes updating display with any messages for the user relevant to the developing graphical report generation solution. As an example, this may include displaying and indication of input/output incompatibility where an output and an input selected for connection by the user have incompatible data types.

Solution compiling module 107 is configured to reduce a graphical report generation solution into an executable FBP file. In some embodiments, the compiling does not include any compatibility or other checking as that was handled simultaneous to the aforementioned graphical development of the graphical report generation solution. Report production module 111 (i.e., the report engine) is configured to execute the aforementioned FBP file to generate the corresponding report, and then provide the corresponding report as an output (e.g., to display 131).

Turning to FIG. 1B, an example computer system 160 is shown in which or with which embodiments of the present disclosure may be utilized. As shown in FIG. 1B, computer system 160 includes an external storage device 170, a bus 172, a main memory 174, a read-only memory 176, a mass storage device 178, one or more communication ports 180, one or more processing resources (e.g., processing circuitry 182), an input/output circuit 184, a user input device 198, and a display 199.

Those skilled in the art will appreciate that computer system 160 may include more than one processing resource 182 and communication port 180. Non-limiting examples of processing resources include, but are not limited to, Intel Quad-Core, Intel i3, Intel i5, Intel i7, Apple Ml, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 180 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g., start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such as front side bus (FSB), which connects processing resources to software systems.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 190 can be any kind of external hard-drives, floppy drives, IOMEGA® Zip Drives, Compact Disc-Read Only Memory (CD-ROM), Compact Disc-Rewritable (CD-RW), Digital Video Disk-Read Only Memory (DVD-ROM). Components described above are meant only to show various possibilities. In no way should the aforementioned example computer systems limit the scope of the present disclosure.

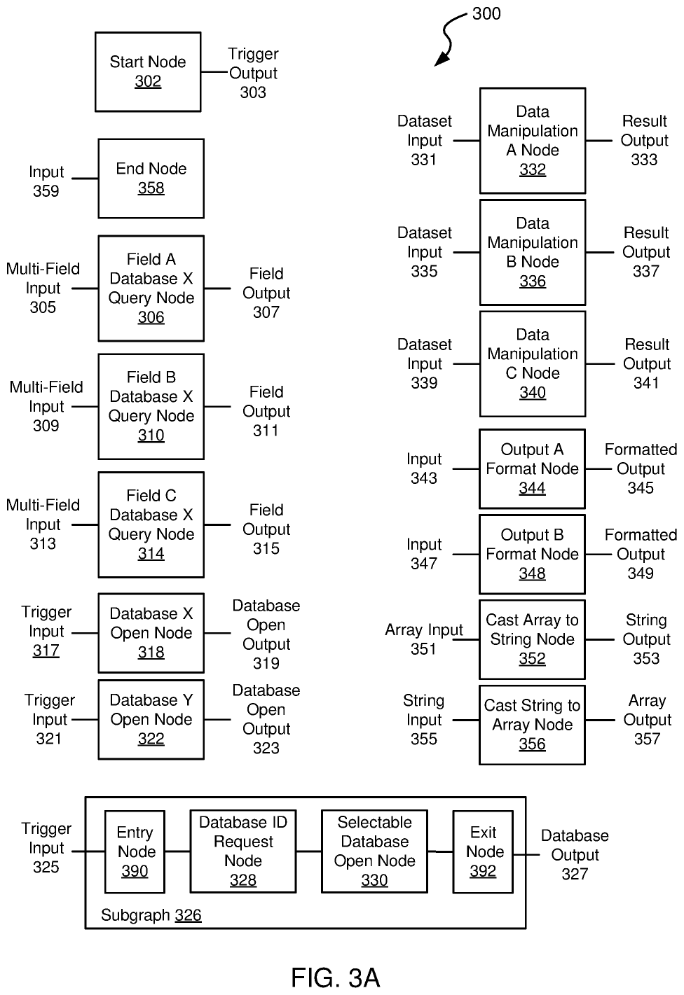

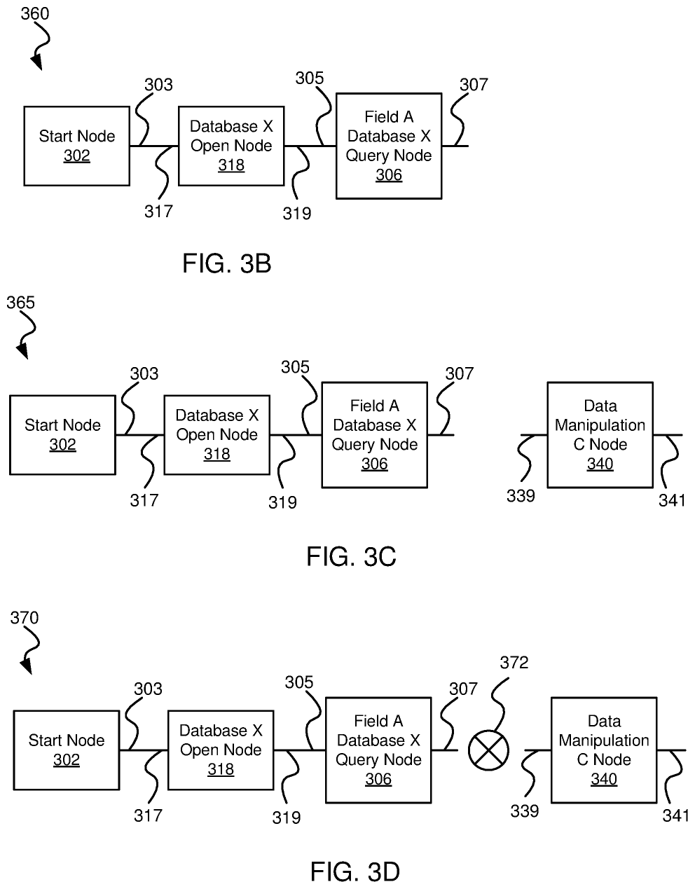

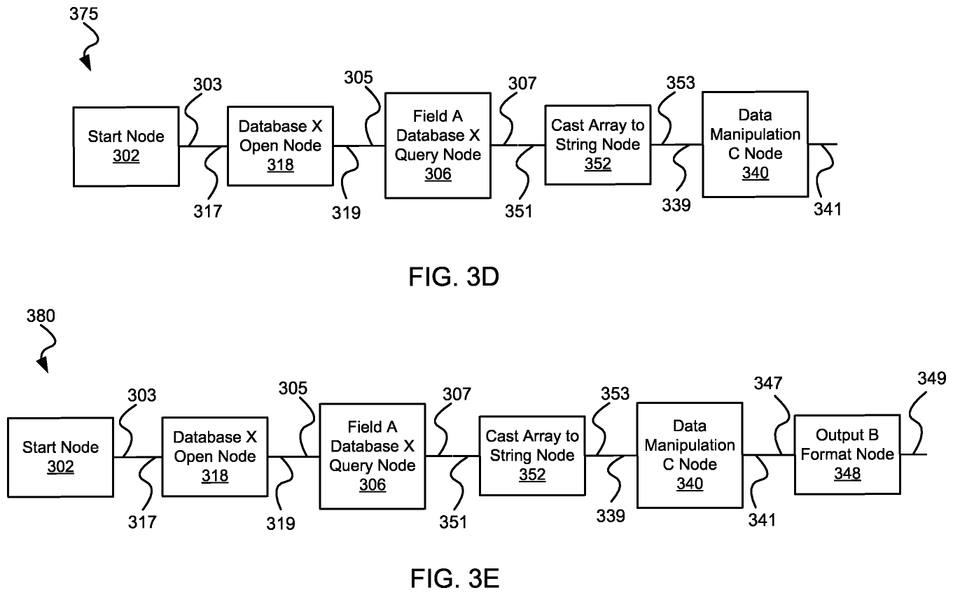

Turning to FIGS. 2A-2C, a flow diagram 200 shows a method in accordance with some embodiments for custom report generation. Following flow diagram 200 of FIG. 2A, graphical processing nodes 202 are accessed (block 202). The graphical processing nodes are a tool set of graphically represented preprogrammed functions that each perform a defined function and include defined inputs and/or outputs. These graphical processing nodes are maintained on a storage medium from which they can be accessed and retrieved. FIG. 3A shows an example set 300 of graphical processing nodes (a start node 302, an end node 358, a field A database X query node 306, a field B database X query node 310, a field C database X query node 314, a database X open node 318, a database Y open node 322, a subgraph 326, a data manipulation A node 332, a data manipulation B node 336, a data manipulation C node 332, an output A format node 344, an output B format node 348, a cast array to string node 352, and a cast string to array node 356). It is noted that example set 300 is just that, an example, and that embodiments may include more or fewer graphical processing nodes, and may include a broad array of graphical processing nodes each designed to perform a different function in relation to generating reports including, but not limited to, opening files, accessing data from files, forming data sets into output formats, recasting data types, manipulating data sets using, for example, mathematical and/or algorithmic processes, forming data sets into output formats. Example set 300 are included as part of a graph IDE.

Start node 302 includes a trigger output 303. Start node 302 is an event receiver that is used to signal the beginning of an execution flow. Where start node 302 is called by a report engine, trigger output is asserted as a signal to a downstream processing node connected to the start node in a developed graphical report generation solution. All graphical report generation solutions begin with an event receiver. A graphical report generation solution without an event receiver is not considered valid, and will fail to run in the report engine. In some embodiments, any graphical report generation solution that does not include an even receiver is automatically augmented to include an event receiver (e.g., start node 302) prepended to the first processing node in the graphical report generation solution so that it can be executed by the report engine.

When an event receiver (e.g., start node 302) is executed within the report engine, each event receiver for the emitted event is executed synchronously in a non-deterministic fashion. When each execution flow reaches its conclusion, the next event receiver is executed to the end of the execution flow.

Database X open node 318 includes a trigger input 317 and a database output 319; and database Y open node 322 includes a trigger input 321 and a database output 323. Database X open node 318 when triggered via trigger input 317 operates to open a preprogrammed database X; and similarly, database Y open node 322 when triggered via trigger input 321 operates to open a preprogrammed database Y. The preprogrammed databases may be any databases known in the art that have a database definition and are accessible using a database access tool. Once database X is open, Database X open node 318 asserts a database open output 319. Similarly, once database Y is open, database Y open node 322 asserts a database open output 323.

Subgraph 326 is similar to both database X open node 318 and database Y open node 322 in that it opens a database, the difference is that it first requests that the user identify the database to be opened. As such the database that is opened is not preprogrammed, but rather is accessed during execution of the graphical report generation solution by the report engine. In particular, subgraph 326 includes two graphical processing nodes that are executed in sequence. The first is a database ID request node 328 and the second is a selectable database open node 330. Database ID request node 328 when executed by a report engine upon assertion of a trigger input 325 by a preceding processing node causes a user input request to be graphically displayed followed by receipt and processing of a user input. The user input is treated as a database to be opened, and this is provided to selectable database open node 330. In turn, selectable database open node 330 operates to open the database identified by the user input.

Subgraph 326 is an example of subgraph nodes which each contain an internal execution sequence. Such subgraph nodes each includes an entry node 391 which, in the example of subgraph 326, would precede database ID request node 328 and an exit node 392 which would follow selectable database open node 330. Any graphical report generation solution or contiguous execution flow of a graphical report generation solution can be refactored into a subgraph. Once the execution flow is refactored into a subgraph, the subgraph may be individually exported and imported, allowing subgraphs to be shared between reports. Further, a subgraph may be cloned within a graph IDE as many times as needed, with a new instance of all graphical processing nodes contained in the subgraph being created on copy. Further, as a subgraph, once formed, can be treated as a processing node, any subgraph may include one or more subgraphs as the internal processing node(s) up to a system limited depth.

Data manipulation A node 332 includes a dataset input 331 and is configured to perform a defined process (i.e., manipulation A) on the received dataset input 331 to yield a result output 333. The defined process may be any mathematical or algorithmic function. As an example, manipulation A may be a process of: (1) counting the total number of entries in the received dataset, (2) identifying different classes of entries in the dataset, (3) counting the number of entries in the dataset that fit into each of the different classes, and (4) providing the total count, and the counts for the respective classes as result output 333. Based upon the disclosure provided herein, one of ordinary skill in the art will recognize a variety of processes or functions that may be applied as manipulation A. Similarly, data manipulation B node 336 includes a dataset input 335 and is configured to perform a defined process (i.e., manipulation B) on the received dataset input 335 to yield a result output 337; and data manipulation C node 340 includes a dataset input 339 and is configured to perform a defined process (i.e., manipulation C) on the received dataset input 339 to yield a result output 341.

Such data manipulation nodes are examples of execution nodes. Execution nodes include a defined sequential process (e.g., the process set forth above: (1) counting the total number of entries in the received dataset, (2) identifying different classes of entries in the dataset, (3) counting the number of entries in the dataset that fit into each of the different classes, and (4) providing the total count, and the counts for the respective classes as result output 333). A subgraph is a special type of execution node where the sequential processes are represented as graphical processing nodes. Other types of execution nodes may simply perform sequential execution based upon a written code rather than a connected series of graphical processing nodes.

Another special type of execution node is a sequence node. A sequence node, like any execution node, performs a series of processes. However, a sequence node includes one or more processes that are selected for execution based upon another process executed within the sequence node. In a sequence node, multiple execution outputs are executed in order, to allow a deterministic execution flow. It takes a single execution input and may have one or more execution outputs. Each input or output may be named automatically or named by the user within the graph IDE. For data inputs, a static value may be entered if no data flow is connecting into the input.

Output A format node 344 receives an input 343 and formats the input into a format A (e.g., a bar graph, a pie chart, a line graph, a histogram, an area chart, a dot graph, a scatter plot, a bubble chart, a PDF™ format document, a WORD™ format document, or one or more combinations of the aforementioned). Based upon the disclosure provided herein, one of ordinary skill in the art will recognize a variety of formats, both simple and compound, that may be used in relation to different embodiments. The formatted input is provided as formatted output 345. Similarly, output B format node 348 receives an input 347 and formats the input into a format B. The formatted input is provided as formatted output 349.

Cast array to string node 352 modifies an array input 351 to be a string output 353. Similarly, cast string to array node 356 modifies a string input 355 to be an array output 357. All inputs and outputs of graphical processing nodes are strictly typed, preventing invalid configurations from being created within the graph IDE. Execution outputs may only connect to execution inputs and data outputs may only connect to a data input that accepts the type of the output. In some cases, data type mismatches may be cured by placing a type conversion node between otherwise incompatible outputs and inputs. Cast array to string node 352 and cast string to array node 356 are examples of such type conversion nodes. To assure simplicity, in some embodiments only conversions between types is allowed where the conversion provides a result which is guaranteed to work in all applications. Thus, for example, in such embodiments, a conversion from a floating point datatype to an integer datatype may not be allowed. Based upon the disclosure provided herein, one of ordinary skill in the art will recognize a variety of conversion nodes that may be used in relation to different embodiments. In some embodiments, each data type is graphically represented with a distinct color, making it easier to distinguish what data type will move through the data flow.

Cast array to string node 352, cast string to array node 356, output A format node 344, and output B format node 348 are examples of data nodes. Unlike execution nodes, data nodes do not have an execution flow, but may receive data from either execution nodes or other data nodes. In some embodiments, such data nodes transmit static values or perform transformative operations on the values, such as converting to another data type. An output from a data node may be output to multiple data inputs, but a data input to a data node may accept an input from only a single output. In contrast, an input to an execution node may accept many execution flows from different execution outputs, but an execution output may connect to only a single execution input.

Some graphical processing nodes may be defined with extensible sets of inputs and outputs. For example, the above described sequence node allows the user to add and remove additional execution outputs from the sequencing node. Some graphical processing nodes may have a finite set of inputs and outputs that may be added, a minimum number of each acceptable input or output, or a maximum number of each acceptable input or output. The set of inputs and outputs may be manipulated within a context menu accessible for each processing node. Other features of the context menu include modifications of the color of a processing node, processing node title, processing node dimensions, and processing node collapse state, allowing the node to be collapsed for readability.

In some embodiments, comment nodes are provided. Such comment nodes exist underneath the other categories of graphical processing nodes visually and surround an area of the graphical processing nodes. Such comment nodes may be used by a user to annotate a section of the Graph with more information, a Comment Node will move all contained nodes when moved within a graphical report generation solution.

Returning to FIG. 2A, the graphical processing nodes are displayed (block 204). In some embodiments, the graphical processing nodes are displayed in a manner that they are selectable using a computer input device such as, for example, a mouse or keyboard. It is determined whether a user has selected a connection socket of a displayed graphical processing node (there may be one or more connection sockets for each graphical processing node) using a computer input (block 206). Where one of the connection sockets has been selected (block 206), it is determined whether the user input has dragged the selected connection socket to a location relative to a connection socket of a previously selected graphical processing node such that an input of the newly selected graphical processing node is near an output of the previously selected graphical processing node (block 208).

As an example, connection of such connection nodes allows for the possibility of a single node (i.e., a node A) being connected to another node (i.e., a node B) directly on a first connection socket, but a second connection socket may connect via other nodes (i.e., a node C and a node D). Following the example, the first connection socket may flow the execution from node A to node B, but the second connection socket may require accessing data members, such as the length of an array, before it can be provided as input to node B.

Where an input of the newly selected graphical processing node is near an output of the previously selected graphical processing node (block 208), compatibility of the input of the newly selected graphical processing node and the output of the previously selected graphical processing node is checked (block 212). Determining compatibility includes determining whether the aforementioned output is the same as the type expected by the aforementioned input. Thus, for example, where the aforementioned input requires a string, it is determined whether the aforementioned output is a string. In some cases, connections are made by other mechanisms than the drag and drop approach set forth in this embodiment.

Alternatively, where the input of the newly selected graphical processing node is not near an output of the previously selected graphical processing node (block 208), it is determined whether an output of the newly selected graphical processing node is near an input of the previously selected graphical processing node (block 210). Where it is determined that an output of the newly selected graphical processing node is near an input of the previously selected graphical processing node (block 210), compatibility of the output of the newly selected graphical processing node and the input of the previously selected graphical processing node is checked (block 214). Again, determining compatibility includes determining whether the aforementioned output is the same as the type expected by the aforementioned input. Thus, for example, where the aforementioned input requires an array, it is determined whether the aforementioned output is an array.

Alternatively, where it is determined that an output of the newly selected graphical processing node is not near an input of the previously selected graphical processing node (block 210), processing returns to block 206.

Where it is found that the proximate output and input are compatible (block 216), a connection is made between the proximate output and input and the display is updated to show the connection (block 220). Turning to FIG. 3B, an example display 360 of three connected graphical processing nodes is shown. In particular, trigger output 303 of start node 302 is connected to trigger input 317 of database X open node 318. This is caused, for example, by first selecting one of database X open node 318 or start node 302 and placing it in a graphical report generation solution area of display 360. Subsequently, the other of database X open node 318 or start node 302 is selected and dragged such that trigger output 303 is near trigger input 317. Once the compatibility between trigger output 303 trigger input 317 is established, a connection is graphically shown between them similar to that shown in display 360. Then, field A database X query node 306 is selected and brought within proximity of database X open node 318 such that database open output 319 is near multi-field input 305. Once the compatibility between database open output 319 and multi-field input 305 is established, a connection is graphically shown between them similar to that shown in display 360. At this juncture, the graphical report generation solution shown in display 360 is configured to open database X, and to access field A of the opened database X.

Returning to FIG. 2A, the processes of blocks 206-220 (including block 240) are repeated as additional graphical processing nodes are selected and added to the graphical generation report.

Alternatively, where it is found that the proximate output and input are not compatible (blocks 212, 214), incompatibility processing is performed (block 240). Block 240 is shown in dashed lines as it includes a number of processes described in relation to a flow diagram of the same number in FIG. 2B. Turning to FIG. 2B and following flow diagram 240, it is determined if a type conversion is possible between the proximate output and input (block 242). A type conversion is possible where a graphical processing node is available that is capable recasting the data type provided from the output to the data type required by the input.

Where no graphical processing node is available that is capable recasting the data type provided from the output to the data type required by the input (block 242), a connection error is indicated (block 248). For example, referring to FIG. 3C, where the data type provided by field output 307 is an integer and the data type required by data input 339 is an array, there is no graphical processing node available to make the data conversion. In such a case, a graphical symbol 372 is shown indicating the incompatibility in place of where a connection would otherwise have been displayed.

Alternatively, where a graphical processing node is available that is capable recasting the data type provided from the output to the data type required by the input (block 242), the available type conversion graphical processing node is connected between the otherwise incompatible inputs/outputs (block 244). Once the connection is complete, the display is updated (block 246). As an example, referring to FIG. 3D, where the data type provided by field output 307 is an array and the data type required by data input 339 is a string, cast array to string node 352 is available and thus it would be determined that a type conversion is possible. In such a case, field output 307 is automatically connected to array input 351 and sting output 353 is automatically connected to data input 339 in a display 380 of a graphical report generation solution area.

Referring again to FIG. 2A, the processes of blocks 206-220 (including block 240) are repeated as additional graphical processing nodes are selected and added to the graphical generation report. The processing continues with the user adding graphical processing nodes to the growing graphical report generation solution until the user indicates that it is complete (block 230). Turning to FIG. 3E, a display 390 shows an example of a completed report generation solution where that of FIG. 3D is further augmented to include output B format node 349. At this juncture, the graphical report generation solution shown in display 390 is configured to open database X, to access field A of the opened database X, to cast the array available from field output 307 to a string which is provided as string output 353 that is compatible with dataset input 339 of data manipulation C node, to perform data manipulation C on the received data set, and to format the resulting manipulated data as B format that is provided as an output.

Once the user indicates that the graphical report generation solution is complete (block 230), completion processing is performed (block 260). Block 260 is shown in dashed lines as it includes a number of processes described in relation to a flow diagram of the same number in FIG. 2C. Turning to FIG. 2C and following flow diagram 260, the completed graphical report generation solution is compiled (block 262). Such compiling may include reducing the graphical report generation solution to an executable FBP file. In some embodiments, the compiling does not include any compatibility or other checking as that was handled simultaneous to the aforementioned graphical development of the graphical report generation solution.

In turn, the executable FBP file is provide to a report engine where it is executed to generate the corresponding report (block 264). The generated report is then provided as an output (block 266).

In conclusion, the present invention provides for novel systems, devices, and methods. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for graphically generating an output document, the method comprising:
displaying, by a processing resource, a plurality of graphical process nodes, wherein each of the plurality of graphical process nodes corresponds to a defined function; and
wherein each of the plurality of process nodes includes at least a defined input and at least a defined output;
receiving, by the processing resource, a first selection of a first graphical process node and a second selection of a second graphical process node, wherein the first graphical process node and the second graphical process nodes are included in the plurality of graphical process nodes;
receiving, by the processing resource, a connection selection, wherein the connection selection commands a connection between the defined output of the first graphical process node and the input of the second graphical process node;
checking, by the processing resource, that the defined output of the first graphical process node is compatible with the defined input of the second graphical process node;
applying, by the processing resource, the connection selection to yield a process including at least the first graphical process node and the second process node; and
running, by the processing resource, the process to generate a user report.

2. The method of claim 1, wherein receiving the connection selection comprises:
receiving, by the processing resource, an indication of the second processing node; and
receiving, by the processing resource, an indication to move the second processing node near the first processing node.

3. The method of claim 1, wherein checking that the defined output of the first graphical process node is compatible with the defined input of the second graphical process node is done upon receiving the connection selection.

4. The method of claim 3, wherein the first graphical process node includes an internal process to select between a first output type and a second output type, and wherein checking that the defined output of the first graphical process node is compatible with the defined input of the second graphical process includes selecting one of the first output type or the second output type based at least in part on the defined input of the second graphical process.

5. The method of claim 3, wherein checking that the defined output of the first graphical process node is compatible with the defined input of the second graphical process includes displaying an error message indicating an incompatibility of the defined output of the first processing node and the defined input of the second processing node.

6. The method of claim 1, wherein the second graphical process node is selected from a group consisting of: an event receiver node, a data node, an execution node, and a comment node.

7. The method of claim 6, wherein the first graphical process node is an event emitter node.

8. The method of claim 1, wherein the second graphical process node includes a third graphical process node, a fourth graphical process node, and a fifth graphical process node from the plurality of graphical process nodes, and wherein each of the third graphical process node, the fourth graphical process node, and the fifth graphical process node are interconnected to yield a function of the second graphical process node.

9. The method of claim 1, wherein running the process to generate a user report includes executing the defined function of the first graphical process node to yield a first output and executing the defined function of the second graphical process node to yield a second output.

10. The method of claim 9, wherein the defined function of the second graphical process node is generating a report in a defined format, and wherein the second output is the report in the defined output.

11. A system for generating reports, the system comprising:
a processing resource;
a non-transitory computer-readable medium, coupled to the processing resource, having stored therein instructions that when executed by the processing resource cause the processing resource to:
display a plurality of graphical process nodes, wherein each of the plurality of graphical process nodes corresponds to a defined function; and wherein each of the plurality of process nodes includes at least a defined input and at least a defined output;
receive a first selection of a first graphical process node and a second selection of a second graphical process node, wherein the first graphical process node and the second graphical process nodes are included in the plurality of graphical process nodes;
receive a connection selection, wherein the connection selection commands a connection between the defined output of the first graphical process node and the input of the second graphical process node;
check that the defined output of the first graphical process node is compatible with the defined input of the second graphical process node;
apply the connection selection to yield a process including at least the first graphical process node and the second process node; and
run the process to generate a user report.

12. The system of claim 11, wherein the instructions to receive the connection selection include instructions, which when executed by the processing resource cause the processing resource to:
receive an indication of the second processing node; and
receive an indication to move the second processing node near the first processing node.

13. The system of claim 11, wherein checking that the defined output of the first graphical process node is compatible with the defined input of the second graphical process node is done upon receiving the connection selection.

14. The system of claim 11, wherein the second graphical process node is selected from a group consisting of: an event receiver node, a data node, an execution node, and a comment node.

15. The system of claim 16, wherein the first graphical process node is an event emitter node.

16. The system of claim 11, wherein the second graphical process node includes a third graphical process node, a fourth graphical process node, and a fifth graphical process node from the plurality of graphical process nodes, and wherein each of the third graphical process node, the fourth graphical process node, and the fifth graphical process node are interconnected to yield a function of the second graphical process node.

17. The method of claim 1, wherein the instructions to run the process to generate the user report include instructions, which when executed by the processing resource cause the processing resource to execute the defined function of the first graphical process node to yield a first output and executing the defined function of the second graphical process node to yield a second output.

18. The method of claim 17, wherein the defined function of the second graphical process node is generating a report in a defined format, and wherein the second output is the report in the defined output.

19. A non-transitory computer-readable storage medium embodying a set of instructions, which when executed by a processing resource of a computer system, causes the processing resource to:
display a plurality of graphical process nodes, wherein each of the plurality of graphical process nodes corresponds to a defined function; and wherein each of the plurality of process nodes includes at least a defined input and at least a defined output;
receive a first selection of a first graphical process node and a second selection of a second graphical process node, wherein the first graphical process node and the second graphical process nodes are included in the plurality of graphical process nodes;
receive a connection selection, wherein the connection selection commands a connection between the defined output of the first graphical process node and the input of the second graphical process node;
check that the defined output of the first graphical process node is compatible with the defined input of the second graphical process node;
apply the connection selection to yield a process including at least the first graphical process node and the second process node; and
run the process to generate a user report.

20. The non-transitory computer-readable medium of claim 19, wherein the instructions to run the process to generate the user report include instructions, which when executed by the processing resource cause the processing resource to execute the defined function of the first graphical process node to yield a first output and executing the defined function of the second graphical process node to yield a second output
